(19) United States
(12) Patent Application Publication
(10) Pub. No.: US 2004/0054642 A1
(43) Pub. Date: Mar. 18, 2004

(54) System for decoding and searching content of file and operation method thereof

(76) Inventor: Po-Zen Chen, Hsinchu (TW)

Correspondence Address: POWELL, GOLDSTEIN, FRAZER & MURPHY LLP, P.O. BOX 97223, WASHINGTON, DC, 20090-7223, US

(21) Appl. No.: 10/244,531

(22) Filed: Sep. 17, 2002

(51) Int. Cl. G06F 7/00

(52) U.S. Cl. 707/1

(57) ABSTRACT

A system for decoding and searching the content of a file and the operation method thereof are disclosed, wherein the present invention is utilized in an automated material handling system (AMHS). By utilizing the present invention, the lot historical record file is downloaded at a predetermined time, and then a decoding device is utilized to decode the content of the lot historical record file and a decoded result is obtained. The decoded result will be stored in an online database, so that the staff can search and check the content of the lot historical record file by connecting to the online database in internet information service through internet or other ways. Therefore, not only the searching speed is rapid, but also the loading of the AMHS is not increased. Meanwhile, wherever the maintainer is, he can maintain the lot historical record file through internet in any time.

### FIELD OF THE INVENTION

The present invention relates to a system for decoding and searching the content of file, and more particularly, to the system implemented in an automated material handling system (AMHS) of semiconductor process. By downloading a lot historical record file to be explained, a decoded result is stored in an online database, so that the staff can inquire and maintain the lot historical record through internet in any time, and meanwhile, the system resource required for maintenance and inquiry is less.

### BACKGROUND OF THE INVENTION

In the IC manufacturing procedure, there are many process steps for wafer nowadays. During these steps, if the wafer is handled by manpower, mistakes are very likely to occur. Furthermore, the IC manufacturing is migrated to the manufacture of larger wafer size to gain the improvement of productivity for enhancing competitiveness. Thus, the 300 mm automated factory will become the main stream in the next generation, wherein it is impossible to handle a wafer by manpower. Moreover, in the semiconductor manufacturing process, human is the major source of pollution. Since the chance for dust and particles to fall on the surface of wafer can be decreased by avoiding human operation, a no-man factory is the ultimate target of building a factory. Based on the factual reasons described above, the development of AMHS is needed.

Some AMHS related operation actions, such as lot transportation, and the complicated movement of depositing or taking-out material, are recorded for the future inquiry by semiconductor equipments. The communication standard between the semiconductor equipments and the main units of computer integrated manufacturing (CIM) is SEMI equipment communication standard (SECS), which is created by Semiconductor Equipment and Materials International (SEMI). Moreover, there are two different sets of SECS standards: SECS-I and SECS-II. The SECS-I standard describes the physical and electric specifications. The SECS-II standard defines the contents of the messages passed between the host computer and the process equipment. The GEM is extended from the SECS-II standard and is a simple version of the SECS-II standard, and is defined for device control. Although the communicative message of SECS-II standard is defined for semiconductor CIM, the communicative message of SECS-II standard is still suitable for other CIM industries.

The code of SECS-II is described as follows. A communicative message of SECS-II standard is composed of a 13 to 257 bytes of 8-bit data. The representation of each byte in the message is a character or a single-digit number. The beginning of each message is a single byte that is labeled with 0 and indicates the total length of the message block, and then, what follows are ten bytes that are labeled with from 1 to 10 and indicate the related identification codes and system information. Then, the followings are data of the message, and the final two bytes are check codes for checking and debugging the message.

The SECS-II standard is used as the communication standard for most of the semiconductor equipments to keep in touch with the main units of CIM closely and to receive the inquiry or control from the main units of CIM, and moreover, to respond the inquiry from the main units of CIM and also report the execution results or the abnormal status of equipments at once.

In AMHS, the computer administering all messages regarding stockings is called CSM, and the computer administering all messages and records of CSM and other correlative messages is called material control system (MCS). All the correlative steps and processes of AMHS are saved into a file by MCS. The contents of the file are usually coded in the mixed mode of American Standard Code Information Interchange (ASCII) and SECS-II, and users can search the needed information in the lot historical record file by the conventional lot historical search system.

The operation of conventional lot historical record search system is to obtain the data in equipments or computers by using a transmissible media, such as DAQ card or input/output card. Then, according to the requirements from users, the required data in a lot historical record file is searched by a batch command called “logsearch” in UNIX operating system. “logsearch” is mainly to explain the data of lot historical record file by using a translative program called “utlogxlt” (which is provided by program designer). Then, a UNIX system command called “Grep” is used to find matched strings, and the result is displayed in the window of UNIX operation system on the screen. Thereafter, the position of data required by user is found by sorting the result in time.

With the increase of economy size, more and more automatic equipments are used, and thus the information system also has to be automated for handling huge and complicated jobs. While using the conventional lot historical record search system to search the correlative historical data of the lot, the date is searched merely with a simple string comparison method in the huge lot historical record file. This searching by simple string comparison method will take a lot of time, and causes inconvenience to user, and particularly, even more time will be taken for searching earlier lot historical records that are many days old. Moreover, a great deal of system resource is consumed while data searching and comparing steps are frequently performed for a long time, thus seriously affecting the performance of AMHS. On the other hand, an administrator needs to maintain and backup the lot historical record file with an assigned computer or device at a predetermined time. Thus, the burden of human resource and operation cost are increased.

### SUMMARY OF THE INVENTION

In view of the background of the invention described above, as the developments of semiconductor process and hardware design, automatic systems are implemented in various areas. Since the size of chip is getting larger, AMHS becomes more important in the semiconductor manufacturing process gradually. While utilizing the conventional lot historical record searching system of AMHS to inquire the related historical data of lot, the historical date is searched merely with a simple string comparison method in the huge lot historical record file. This searching will take a lot of time and consume a great deal of system resource in data searching and comparing, so that the performance of AMHS is affected seriously. On the other hand, an administrator needs to maintain and backup the lot historical record file with an assigned computer or device at a predetermined time. Thus, the burden of human resource and operation cost are increased. It is the principal object of the present invention to provide a system for decoding and searching the content of a file and the operation method thereof, wherein the system is utilized in an AMHS of semiconductor manufacturing process. By utilizing a file download program to download the lot historical record file from a conventional lot historical record searching system to a system for decoding and searching the content of a file, in order to explain the lot historical record file. Then, the decoded result will be stored in an online database. Therefore, wherever the staff is, he can inquire and maintain the lot historical record through internet at any time, and the system resource required for processing maintenance and inquiry is less.

According to the aforementioned objects of the present invention, the present invention provides a system for decoding and searching the content of a file and the operation method thereof, the system for decoding and searching the content of a file comprising: a transmission device having features of file downloading and file uploading, wherein the transmission device is used to download a lot historical record file from an AMHS; a reading device used to receive the lot historical record file and to read a plurality of data from the lot historical record file; and a decoding device used to receive the plurality of data read from the lot historical record file by the reading device, and to perform a decoding process with the plurality of data for obtaining a decoded result, and then the decoded result is uploaded to a store device by using the transmission device, wherein the decoding device comprises: an ASCII code decoding device used to perform an ASCII code decoding process with the plurality of data read from the lot historical record file for obtaining an ASCII code decoded result of the decoded result; and a SECS-II code decoding device used to perform a SECS-II code decoding process with the plurality of data read from the lot historical record file for obtaining a SECS-II code decoded result of the decoded result.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing the system structure of a preferred embodiment of the present invention; and

FIG. 2 is an operation flow chart of a preferred embodiment of the present invention.

### DETAILED DESCRIPTION OF THE PREFERRED EMBODIMENT

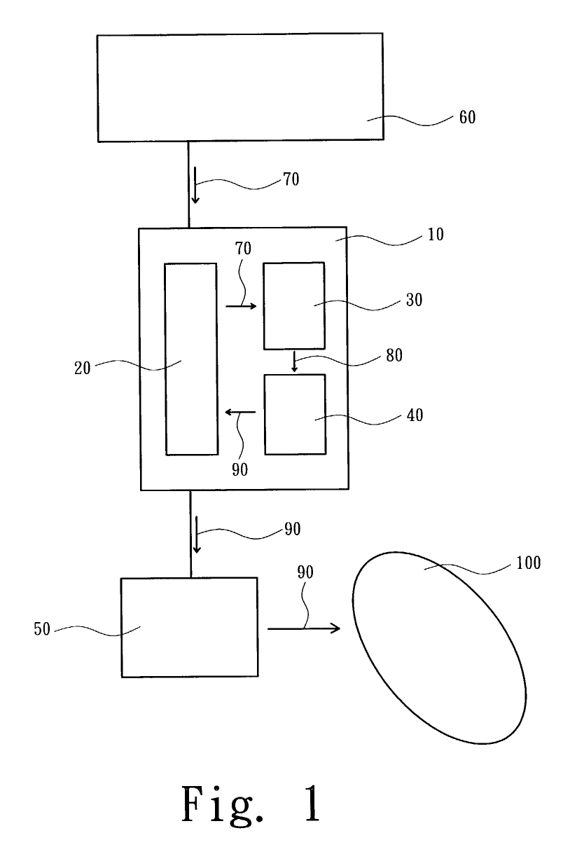

Referring to FIG. 1, FIG. 1 is a diagram showing the system structure of a preferred embodiment of the present invention. As shown in FIG. 1, the system 10 for decoding and searching content of file of the present invention comprises a transmission device 20, a reading device 30, a decoding device 40 and a store device 50, such as an online database.

About the operation theorem of the system 10 for decoding and searching content of file of the present invention, at first, the transmission device 20 connected with an AMHS 60, such as a transmission device having file downloading and file uploading, is utilized to download a lot historical record file from the AMHS 60 to a reading device 30 of the system 10 for decoding and searching content of file. Then, the reading device 30 reads and sends a data 80 consisting of ASCII codes and SECS-II codes from the lot historical record file 70 to a decoding device 40. According to the definitions of ASCII code and SECS-II code of lot historical record file 70, the decoding device 40 performs an ASCII code decoding process and a SECS-II code decoding process with a plurality of ASCII codes of the data 80 and a plurality of SECS-II codes of the data 80, respectively, and then a decoded result is obtained after decoding and is stored into a store device 50, such as an online database, by utilizing the feature of file uploading of the transmission device 20. Therefore, wherever an user is, he can inquire the lot historical record through internet 100 at any time, or perform a remote maintenance to the online database.

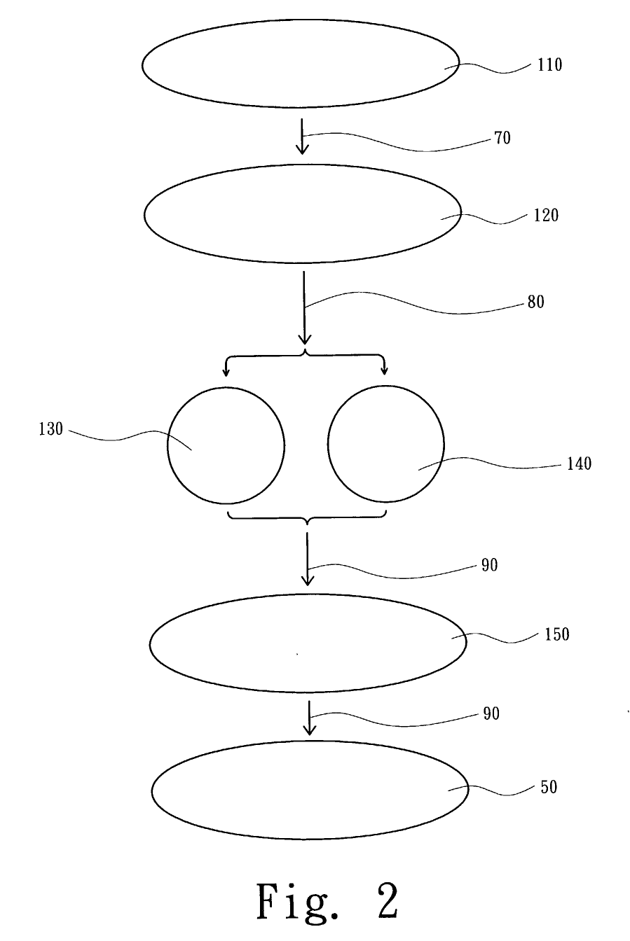

The system 10 for decoding and searching content of file of the present invention can be specified by a main program (1) and FIG. 2 in details. Please referring to FIG. 2, FIG. 2 is an operation flow chart of a preferred embodiment of the present invention.

| | |
|---|---|
| Main( ){ | (1) |

GetFtpFile( );
GetOneData( );
SplitAsciiData( ):
SplitSecsiiData( );
PutData( );

}

In the main program (1), the transmission device 20 performs a downloading step 110 that utilizes a function GetFtpFile( ) to download the lot historical record file 70 from the AMHS 60 to the reading device 30; the reading device 30 performs a reading step 120 that utilizes a function GetOneData( ) to read and send a data 80 consisting of ASCII codes and SECS-II codes from the lot historical record file 70 to a decoding device 40; the decoding device 40 performs an ASCII code decoding step 130 that utilizes a function SplitAsciiData( ) to perform an ASCII code decoding process with the data 80 consisting of ASCII codes and SECS-II codes; the decoding device 40 performs a SECS-II code decoding step 140 that utilizes a function SplitSecsiiData( ) to perform an SECS-II code decoding process with the data 80 consisting of ASCII codes and SECS-II codes; thereafter the transmission device 20 performs a uploading step 150 that utilizes a function PutData( ) to store a decoded result 90 obtained from the ASCII code decoding step 130 and from the SECS-II code decoding step 140 to a store device 50.

The operational principle of the decoding device 40 of the system 10 for decoding and searching content of file is to decode and explain the lot historical record file 70 for obtaining a text content corresponding to ASCII code and SECS-II first, and then the codes, to which various strings of the text content correspond, are found and obtained by reversely searching the lot historical record file in accordance with the aforementioned text content. By comparing and summarizing a plurality of codes, which are corresponding to various text content, the ASCII codes and the SECS-II codes of correlative text content, such as lot number, date and time of depositing and withdrawing, location and flow record, etc., in lot historical record file 70 can be known. Then, according to the lot historical record data that are supposed to be provided to users, an ASCII code decoding process and a SECS-II code decoding process are performed with the related ASCII codes and the related SECS-II codes of the lot historical record file 70, and then a decoded result is obtained and stored into a store device 50.

In order to introduce the operational principle of decoding device of the system 10 for decoding and searching content of file, an example of the partial contents selected from the text file, which is the result after a lot historical record file is decoded and explained, is described as follows.

16-Mar-200.1 15:19:42 CSMC11 ->I Move Lot Request Send: Lot Id: [22100903] Tray Id: [22100903] Carrier ID1: [22100903] carrier Id2: [ ] #Available Locations: [Eq. Unavailable] Current Location: [SKC1-1] Lot Description: [ ] Operation Description: [Created by Device Handler] Lot Priority: [5] Start Move Time: [Mar. 16, 2001 15:19:41] Abnormal Flag: [No]

The outline of the aforementioned data is that: a delivery request of a lot block is informed by CSMC11 warehouse to MCS, wherein the block number is 22100903. While using edit software to open the lot historical file 70, many hexadecimal codes are found, wherein the codes comprise a portion coded by ASCII code and a portion coded by SECS-II code. After comparison, summarization and analysis, the regulation can be shown as follows.

For the part in ASCII code:

| Contents of | Corresponding Part | |
|---|---|---|
| Text File | of ASCII Code | Footnotes |
| CSM | 43 53 4D | The beginning code of the |
| | | data that follows 0A will be |
| | | 43 53 4D. Thatmeans |
| | | “CSM”. |
| C11 | 43 31 31 | This is the stocker number |
| | | of the region. |
| ->1 | 2D 3E 49 | |
| Mar. 16, 2001 | 31 26 2D 4D 61 72 2D 32 | Date |
| | 30 30 31 | |
| 15:19:42 | 31 35 3A 31 39 3A 34 32 | Time |
| | 7F | The length of data ' total is |
| | | “127” Bytes. |

For the part in SECS-II code:

| Contents of | Corresponding Part | |
|---|---|---|
| Text File | of SECS-II Code | Footnotes |
| 56SF1 | C1 01 | Wbit = 1 ' Move Lot |
| | | Request Send |
| 22100903 | 32 32 31 30 30 39 30 33 | Lot_Id |
| 22100903 | 32 32 31 30 30 39 30 33 | Tray_Id |
| 2D819300 | 32 44 38 31 39 33 30 30 | The contents of Carrier |
| | | Id1 |
| | 41 00 | Carrier Id2 is “0” Byte |
| 32766 | 7FFE | The contents of |
| | | Available_Location |
| SKC1-1 | 53 4B 43 31 2D 31 | The contents of |
| | | Current Location |
| | 41 00 | Byte-Lot Description is |
| | | 37 0” Byte |
| Created by Device | 43 72 65. . . | The contents of |
| Handler | | Operation Description |
| 5 | 05 | The contents of Lot |
| | | Priority |
| 20010316151941 | 32 30 30. . . | The contents of |
| | | Start_Move_Time |
| 0 | 00 | The Contents of |
| | | Abnormal_Flag is “0”. |
| | | That means none. |

According to the aforementioned description, after comparing the text contents with the ASCII codes and the SECS-II codes, a coding regularity of lot historical record file is found. Therefore, an ASCII code decoding process and a SECS-II code decoding process are performed to the lot historical record file.

The ASCII code decoding process, i.e. the function SplitAsciiData( ) of the main program (1), is in accordance with the coding standard of American Standard Code Information Interchange to decode the portion coded by ASCII code in the lot historical record file 70. The SECS-II code decoding process, i.e. the function SplitSecsiiData( ) of the main program (1), is described in the following example.

For example, the lot historical record file contains a plurality of SECS-II codes that are 01 02 41 08 32 44 38 31 39 33 30 30 41 00 A9 02 7F FE, and the steps of the SECS-II code decoding process are briefly listed as follows:

| | |
|---|---|
| Idx=0 | 1. |
| SecsIdx=0 | 2. |
| Sub SpitSecsiiData( Byref SECSIIMessage( ) as Variant) | 3. |
| Idx=Idx+1 | 4. |
| Select Case SECSIIMessage(Idx−1) | 5. |
| Case 1 | 6. |

| | |
|---|---|
| Idx=Idx+1 | 7. |
| Icnt=SECSIIMessage(Idx−1) | 8. |
| For I=1 to Icnt | 9. |

| | |
|---|---|
| Call Process(SECSIIMessage) | 10. |

| | |
|---|---|
| Next | 11. |

| | |
|---|---|
| Case 41 | 12. |

| | |
|---|---|
| Idx=Idx+1 | 13. |
| iCnt=Dex(SECSIIMessage(Idx−1) ) | 14. |
| If iCnt>0 then | 15. |

| | |
|---|---|
| For I=1 to iCnt | 16. |

| | |
|---|---|
| Idx=Idx+1 | 17. |
| SecsData=SecsData+SECSIIMessage(Idx−1) | 18. |

| | |
|---|---|
| Next | 19. |
| SecsIdx=SecsIdx+1 | 20. |
| ReDim Preserve TmpSecs(SecsIdx) | 21. |
| TmpSecs(SecsIdx−1)=SecsData | 22. |

| | |
|---|---|
| Else | 23. |

| | |
|---|---|
| SecsData=SecsData+Message(Idx−1) | 24. |
| SecsIdx=SecsIdx+1 | 25. |
| ReDim Preserve TmpSecs(SecsIdx) | 26. |
| TmpSecs(SecsIdx−1)=SecsData | 27. |

| | |
|---|---|
| End if | 28. |
| Case A9 | 29. |
| . . . . . . | 30. |
| End Select | 31. |
| End Sub | 32. |

First, the first row declares the variable Idx to be zero, wherein the variable Idx indicates the location of the aforementioned SECS-II codes (01 02 41 08 32 44 38 31 39 33 30 30 41 00 A9 02 7F FE) at which the process vector is located, and Idx=0 means that the process vector is located at “01“; the second row declares the variable SecsIdx to be zero, wherein the variable SecsIdx indicates the location of a SECS-II array to which the decoded data is saved, and SecsIdx=0 means that the decoded data is saved to the zero location of the SECS-II array; the third row declares a function SplitSecsiiData and reference a function SECSIIMessage( ); the fourth row indicates that the process vector points to “02“of the aforementioned SECS-II codes (01 02 41 08 32 44 38 31 39 33 30 30 41 00 A9 02 7F FE) since Idx=1; the fifth row selects appropriate process procedure according to a result obtained by the function SECSIIMessage( )decoding the SECS-II code pointed by the process vector, i.e., because of Idx=1 and SECSIIMessage(Idx−1), which means SECSIIMessage(0), the result obtained by function SECSIIMessage( ) decodes Idx−1 is “01” (while Idx=0, the process vector points to “01”), so that Case 01 process procedure is chosen.

The sixth row indicates the beginning of Case 01, and according to the coding definition of SECS-II, “01“is an item so that no data is processed in the Case 01 process procedure but Idx is accumulatively added for moving the process vector to other locations; the seventh row performs the step of Idx=Idx+1; the eighth row to declares that a variable Icnt is the result of decoding Idx−1 by function SECSIIMessage( ) and is “02“while Idx=2, i.e. Icnt=2; the ninth row performs For loop, and the condition of For loop is the variable I from 1 to Icnt; the tenth row calls function SplitSecsiiData(Byref SECSIIMessage( ) as Variant) to repeat the step shown in the fifth row, which means selecting appropriate process procedure according to the result obtained by function SECSIIMessage( ) decoding the accumulative Idx; the eleventh row indicates the ending of Case 01 process procedure and performing the subsequent step.

Then, according to the For loop and the condition of For loop in the Case 01 process procedure, it is restarted from the third row; after Idx=Idx+1 shown in the fourth row, Idx=3; according to the result of SECSIIMessage(Idx−1) shown in the fifth row, the Case 41 process procedure is chosen.

The twelfth row declares the beginning of Case 41 process procedure, and according to the coding definition of SECS-II, the following is ASCII form; the thirteenth row indicates performing Idx=Idx+1; the fourteenth row indicates declaring variable iCnt and using function Dec( ) to calculate the result obtained by function SECSIIMessage( ) decoding Idx−1, and iCnt=Dex(08)=8 since Idx=4 and the result obtained by function SECSIIMessage( ) decoding Idx−1 is 08, wherein function Dex( ) is used to transform hexadecimal number to decimal number; the fifteenth row and the twenty-second row indicate using a syntax of if . . . then . . . that performs the steps from the sixteenth row to the twenty-second row if the variable iCnt shown in the fourteenth row is larger than zero, or performs the steps from the twenty-fourth row to the twenty-eighth row; If the variable iCnt is larger than zero, For loop shown in the sixteenth row is performed and the condition of the For loop is that the variable I is from 1 to iCnt; the seventeenth row indicates performing Idx=Idx+1 step so that Idx=5; the eighteenth row declares a variable SecsData for temporarily saving the result obtained by SECSIIMessage decoding Idx−1; the nineteenth row indicates performing the Next step; the twentieth row and the twenty-first row indicate performing SecsIdx=SecsIdx+1 first to make SecsIdx=1, and using a command Redim to change the size of array TempSecs to be SecsIdx; the twenty-second row indicates saving the variable SecsData obtained from the step shown in the eighteenth row into a position of the array TempSecs, wherein the position is decided by SecsIdx−1; then, if iCnt is not larger than zero, i.e. iCnt=0, the step shown in the twenty-fourth row is performed to use SecsData for temporarily saving the result obtained by SECSIIMessage decoding Idx−1; the twenty-fiifth row and the twenty-sixth row indicate performing SecsIdx=SecsIdx+1 first to make SecsIdx=1, and using a command Redim to change the size of array TempSecs to be SecsIdx; the twenty-seventh row indicates saving the variable SecsData obtained from the step shown in the twenty-fourth row into a position of the array TempSecs, wherein the position is decided by SecsIdx−1; the twenty-eighth row indicates the ending of the syntax of If . . . Else . . . and the ending of Case 41 process procedure.

Since the content coded by SECS-II is so enormous and is corresponding to various process procedures, other process procedures and steps of the SECS-II code decoding process are ongoing from the twenty-ninth row and are corresponding to various process procedures but herein are not shown in detail. Finally the thirty-first row and the thirty-second row indicate the ending of the SECS-II code decoding process.

After performing SplitSecsiiData( ) and obtaining the decoded result of SECS-II code related to the data 80 (according to the aforementioned description of SECS-II code decoding process, the decoded result of SECS-II code is presented in array form), a function PutData( ) is implemented by using the transmission device 20, in order to store the decoded result 90, which consists of the decoded result of ASCII code and the decoded result of SECS-II code, into the store device 50.

If the store device 50 is an online database, staffs or users can connect to the online database for inquiry through internet information service (IIS) by internet 100 at any place and any time while demanding to inquire the lot historical record file 70 in AMHS. Therefore, the demanded information can be obtained rapidly, and the system resource used by AMHS is decreased, and the maintainer can perform maintenance to the online database through internet 100, so that the convenience of maintenance is increased.

On the other hand, after properly presetting the system for decoding and searching the content of file according to the present invention, the lot historical record file 70 can be downloaded automatically from AMHS to the system for decoding and searching the content of file for processing after a time interval, such as three hours interval, and then the decoded result is stored into the store device 50, in order to update the records in the store device 50. Therefore, the lot historical record file 70 is backuped and updated efficiently, and the newest lot historical record is provided to users.

The advantage of the present invention is to provide a system for decoding and searching the content of file and the operation method thereof, which are utilized in an AMHS or semiconductor manufacturing process. By Downloading the lot historical record file from AMHS at a predetermined time and performing an ASCII code decoding process and a SECS-II code decoding process with the lot historical record file, a decoded result is obtained and stored into an online database, so that staff can connect to the online database to inquire the content of the lot historical record file through internet in any time, and maintainer can maintain the lot historical record file through internet in any time as well, and the system loading of AMHS is decreased.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A system for decoding and searching the content of file, is used in an AMHS of a semiconductor process, comprising:
a transmission device which has a download function and an upload function, the transmission device using the download function to download a lot historical record file from the AMHS;
a reading device which is used to receive the lot historical record file and to perform a reading step to read a data from the lot historical record file; and
a decoding device which is used to receive the data and to perform a decoding step to the data for obtaining a decoded result, and then the upload function of the transmission device is used to send the decoded result to a store device, wherein the decoding device comprises:
an ASCII code decoding device which is used to perform an ASCII code decoding step to the data for obtaining an ASCII code decoded result of the decoded result corresponding to the data; and
a SECS-II code decoding device which is used to perform a SECS-II code decoding step to the data for obtaining a SECS-II code decoded result of the decoded result corresponding to the data.

2. The system for decoding and searching the content of file according to claim 1, wherein the store device is an online database.

3. The system for decoding and searching the content of file according to claim 1, wherein the download function is a file download function.

4. The system for decoding and searching the content of file according to claim 1, wherein the upload function is a file upload function.

5. A operation method of system for decoding and searching the content of file, is used in an AMHS of a semiconductor process, the operation method comprising:
performing a download step from the AMHS for obtaining a lot historical record file;
performing a reading step to the lot historical record file for obtaining a data of the lot historical record file;
performing a decoding step to the data for obtaining a decoded result; and
performing a upload step to send and store the decoded result into a store device.

6. The operation method of system for decoding and searching the content of file according to claim 5, wherein performing the decoding step comprises performing an ASCII code decoding step to the data for obtaining an ASCII code decoded result of the decoded result.

7. The operation method of system for decoding and searching the content of file according to claim 6, wherein the ASCII code decoding step is performed in accordance with an ASCII coding definition of the lot historical record file.

8. The operation method of system for decoding and searching the content of file according to claim 5, wherein performing the decoding step at least comprises performing a SECS-II code decoding step to the data for obtaining a SECS-II code decoded result of the decoded result.

9. The operation method of system for decoding and searching the content of file according to claim 8, wherein the SECS-II code decoding step is performed in accordance with an SECS-II coding definition of the lot historical record file.

10. The operation method of system for decoding and searching the content of file according to claim 5, wherein the data is coded by ASCII code and SECS-II code in hybrid.

11. The operation method of system for decoding and searching the content of file according to claim 5, wherein the store device is an online database.
